(19) United States
(12) Patent Application Publication
(10) Pub. No.: US 2004/0145605 A1
(43) Pub. Date: Jul. 29, 2004

(54) Access method and system for remote desktops

(76) Inventors: Sujoy Basu, Mountain View, CA (US); Rajendra Kumar, Los Altos, CA (US)

Correspondence Address: HEWLETT-PACKARD COMPANY, Intellectual Property Administration, P.O. Box 272400, Fort Collins, CO, 80527-2400, US

(21) Appl. No.: 10/353,468

(22) Filed: Jan. 28, 2003

(51) Int. Cl. G09G 5/00

(52) U.S. Cl. 345/740; 345/779; 345/733; 345/748; 345/751

(57) ABSTRACT

A method and apparatus is used for accessing a remote desktop from a local computer. Accessing the remote desktop includes requesting a remote desktop to be displayed on the local computer and computed by a remote computer having selected computer resources, identifying the remote computer having the selected computer resources available for immediate use, instructing the remote computer identified to reserve the selected computer resources for use on the local computer, and notifying the local computer to commence communication with the identified remote computer and displaying a desktop from the remote computer on the local computer.

### BACKGROUND OF THE INVENTION

The present invention relates to accessing a remote desktop on a local computer. A growing number of users operate on computers in a networked environment. These networks enable engineers and others to run applications on remote computers rather than on their primary desktop or local computer. While a majority of the applications are loaded on their primary desktop, there are generally a few applications or data sets available only on a remote computer. These applications or data may only run on certain operating systems like UNIX, Linux, or even MacOS. Other times, the user's primary desktop may not have the processing power or storage capabilities present on the remote computer. For example, an engineer designing computer chips with software running on a UNIX/Linux computer may occasionally need to access and run office productivity applications on a Windows desktop.

In a client-server computing environment, several applications have been developed for users to access remote computers and their resources through a remote desktop. Typically, a client portion running on the local computer renders the desktop on the local computer while a server portion of the application runs on the remote computer delivering the remote desktop and managing interactions with the windows and applications in the remote desktop. Virtual Network Computing (VNC) software developed by AT&T Labs, United Kingdom is one software application that provides this functionality on UNIX and the UNIX-like operating system Linux. Both the client and server portions of VNC run on both Windows and UNIX platforms.

Unfortunately, setting up and using VNC for accessing remote desktops is non-trivial and sometimes rather complex. For each remote desktop, the user must start a VNC server process on the remote computer in advance with very specific parameters before the VNC client process can be executed. These parameters describe unique and necessary connectivity information between the local computer and the remote computer running the VNC client and VNC server process respectively.

If the remote computer is accessed occasionally, the user may not remember the connectivity parameters and/or the VNC server process may not always be running. Even if the VNC server processes could be kept running on many remote computers, it may be difficult to remember all the different connectivity requirements, capabilities of the various machines, and applications available on the various machines without compromising security and flexibility. Running several applications on remote computers simultaneously from a local computer only exacerbates these problems. Further, while VNC is one program for sharing remote desktops many other similar programs to VNC suffer from these and other similar related issues.

### SUMMARY OF THE INVENTION

One aspect of the invention features accessing a remote desktop from a local computer. Accessing the remote desktop includes requesting a remote desktop to be displayed on the local computer and computed by a remote computer having selected computer resources, identifying the remote computer having the selected computer resources available for immediate use, instructing the identified remote computer to reserve the selected computer resources for use by the local computer, and notifying the local computer to commence communication with the identified remote computer and display a remote desktop from the remote computer on the local computer.

Another aspect of the invention describes generating a request for computer resources on a remote computer. Generating the request includes creating on a local computer an iconic representation in a graphical user interface for a remote desktop on a remote computer, associating desired computer resources with the iconic representation of the remote desktop, and registering the iconic representation and associated computer resources with a remote computer server capable of locating the remote computer with the desired computer resources upon demand.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a block diagram depicting a networked system having a local computer and several remote computers designed in accordance with one implementation of the present invention;

FIG. 2 provides a flowchart diagram of the operations for setting up remote desktops and desired computer resources compatible with one implementation of the present invention;

FIG. 3 is a block diagram depicting tables used to associated icons and users with computer resources in accordance with one implementation of the present invention;

FIG. 4 is a flowchart diagram of the operations for accessing a remote desktop from a local computer in accordance with one implementation of the present invention; and

FIG. 5 is a block diagram of a system used in one implementation for performing an apparatus or method of the present invention.

### DETAILED DESCRIPTION

Aspects of the present invention are advantageous in at least one or more of the following ways. A local computer can use computer resources on a remote computer through a remote desktop running on the local computer. Using implementations of the present invention, the remote desktop on the local computer is invoked with minimal effort on the user's behalf using a single-click or indication from a mouse or similar device. The user specifies desired computer resources and an implementation of the present invention automatically identifies the remote computer with substantially the closest matching resources. This approach is easier to use because the user specifies a set of desired computer resources rather than a specific computer. If a computer with the desired resources is down or not available, the system and methods associated with the present invention automatically find another computer with substantially the same or similar resources without requiring significant user intervention.

Implementations of the present invention can be used to improve remote desktop invocation in large computing environments. For example, implementations of the present invention keep track of computer resources and updates to a network topology and nodes on a network as they change over time. Users are not required to know or understand these network topologies and/or available nodes on the network to perform tasks or complete projects. Instead, implementations of the present invention only need the user to specify the desired computing resources and optionally the applications to run on a remote computer. The user invokes the remote desktop and remote computer resources subsequently with a single-click or other minimal effort on demand.

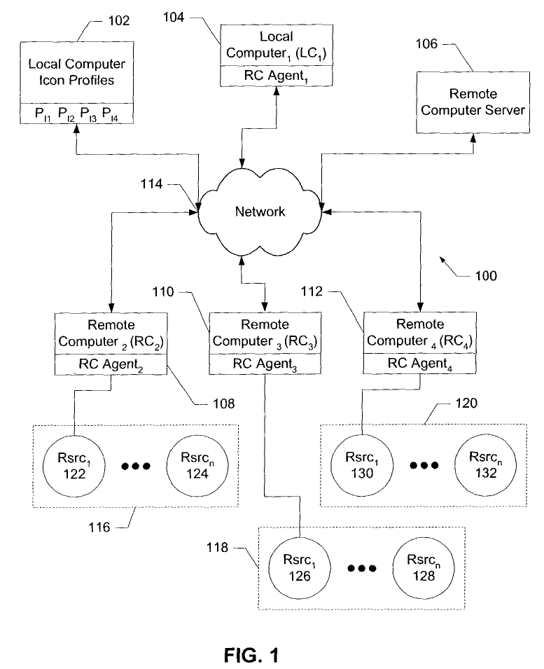

FIG. 1 is a block diagram depicting a networked system 100 having a local computer and several remote computers designed in accordance with one implementation of the present invention. System 100 includes local computer icon profiles 102, a local computer (LC₁) 104 including a remote computer (RC) Agent₁ a remote computer server 106, a remote computer (RC₂) 108 with a remote computer agent (RC) Agent₂, a remote computer (RC₃) 110 with a remote computer (RC) Agent₃, and a remote computer (RC₄) 112 with a remote computer (RC) Agent₄. Each of RC₂ 108, RC₃ 110, and RC₄ 112 have resources 116, 118, and 120 containing Rsrc₁ 122 through Rsrcₙ 124, Rsrc₁ 126 through Rsrcₙ 128, Rsrc₁ 130 through Rsrcₙ 132 respectively.

In operation, LC₁ 104 communicates a users request for computer resources to the corresponding RC Agent₁. On behalf of LC₁ 104 and the user, RC Agent₁ communicates the request to remote computer server 106 to locate a remote computer (RC) with the requested computer resources available. One or more communication sessions with RC Agent₂, RC Agent₃, and RC Agent₄ determines which of RC₂ 108, RC₃ 110, and RC₄ 112 most closely meets the desired computer resource requirements. RC Agent₂, RC Agent₃, and RC Agent₄ carefully checks Rsrc₁ 122 through Rsrcₙ 124, Rsrc₁ 126 through Rsrcₙ 128, and Rsrc₁ 130 through Rsrcₙ 132, for both the existence and availability of respective resources, and reports back results to remote computer server 106 for a selection decision. For example, resources on each remote computer may be categorized as a processor capacity, a disk storage amount, a network bandwidth, a cache amount, a memory amount, and applications available on the remote computer. While these are more typically requested computer resources, many other computer resources or characteristics could be included depending on the particular needs of the users and the requests for computer resources they make.

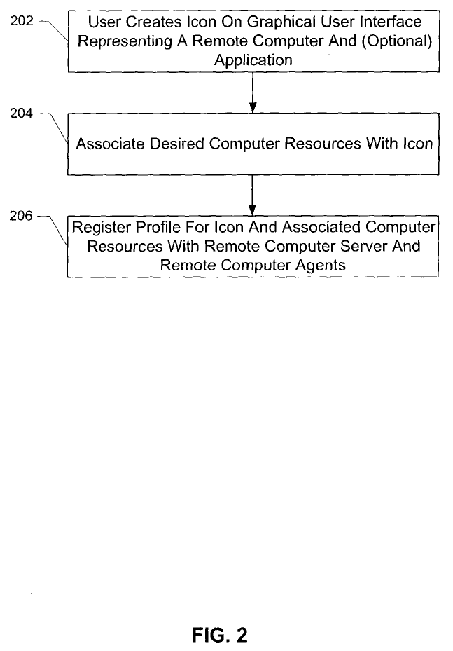

FIG. 2 provides a flowchart diagram of the operations for setting up a remote desktop and desired computer resources in accordance with one implementation of the present invention. Using the present invention, a user creates one or more icons on the local computer desktop representing different requests for computer resources. The actual remote desktop and corresponding remote computer represented by the icon depends on what remote computer and computer resources are available when the icon is actually selected.

Accordingly, a user initially creates one or more of these icons in their desktop environment representing a remote computer and (optionally) a particular application (202). This creates on a local computer an iconic representation in a graphical user interface of a remote desktop from a remote computer even though it is not determined which remote computer will provide the remote desktop and computer resources. If the user also specifies an application, the remote computer may also be required to invoke the particular application for the user when the remote desktop is generated on the local computer.

Each icon is then associated with one or more desired computer resources as requested by the user or required by the application (204). In one implementation, the user selects the desired resources for the remote desktop based on personal preferences. The user can specify particular computer resources, a range of acceptable computer resources, and may even prioritize the computer resources. In one implementation, the computer resource categories could include: a processor capacity, a disk storage amount, a network bandwidth, a cache amount, a memory amount, and applications available on the remote computer. For example, the user can indicate a low to high speed processor, a storage requirement from 200 Gigabytes to 500 Gigabytes, and at least a 2 Gigabit of communication bandwidth on the remote computer. Further, the user can specify that the processor speed is the highest priority while the storage requirement is the lowest priority when selecting an appropriate remote computer. Alternate priorities can be assigned to different computer resources.

Alternatively, the computer resources for the remote desktop can be predetermined depending on the work required by one or more particular applications. If a particular application is specified, default computer resources may be predetermined and included in the iconic definition on the local computer desktop. For example, a video editing application may require a computer with advanced rendering capabilities, large amounts of cache, and increased storage capabilities to handle high-speed video editing requirements. In this alternate implementation, a user would specify the desired application and the computer resources would automatically be included in the iconic representation of the remote desktop.

Once the computer resources are determined, the icon and associated computer resources are registered with a remote computer server designed to locate a remote computer on demand having the desired computer resources (206). In one implementation, the registration includes grouping the icon and the desired computer resources together in a profile. The profile can be a file, an object, or other type of storage unit accessible by the local computer, the remote computer server, the remote computer agents, and any other methods and systems used by implementations of the present invention. For example, the profile can be stored on the local computer, the computer system running the remote computer server process, or can be stored on one or more remote computers.

In addition, registering the profile (206) can also include authenticating and authorizing the user associated with the iconic representation of the remote desktop. To save time, implementations of the present invention can verify in advance that a user has authorization to access computer resources on one or more computers in the network. The user may be required to provide authentication information during the setup consistent with Kerberos, Lightweight Directory Access Protocol (LDAP), or other pluggable authentication modules (PAM). Other types of authentication not compatible with PAM may also be used. Authenticating and authorizing users in advance both saves times and simplifies access to remote computing resources.

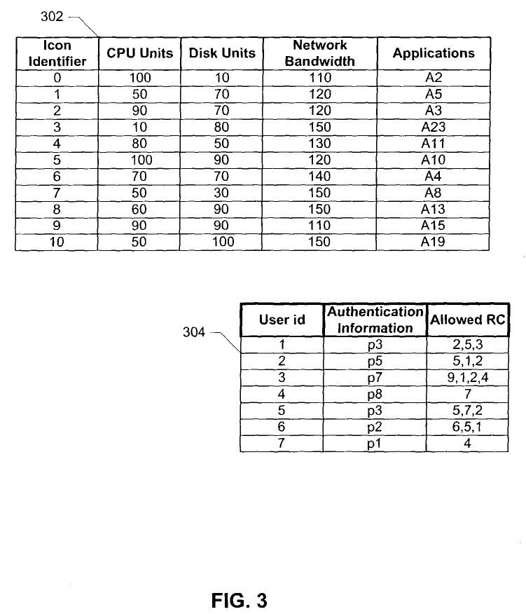

FIG. 3 is a block diagram depicting tables used to associated icons and users with computer resources in accordance with one implementation of the present invention. Icon table 302 includes icon identifiers, CPU units, disk units, network bandwidth, and applications.

In one implementation, each icon identifier represents an icon on the user. In an X Windows environment, the icon may further specify the local computer, the terminal, and the particular display on which the icon is located. For example, an icon identifier can be associated with a particular host, display and screen number by specifying <host>:<display>.<screennumber> along with the particular icon identification information. Screen number refers to the particular screen when a system has multiple terminals or screens in use. X Windows based remote desktop applications like Virtual Network Computing (VNC) developed by AT&T use this information to identify the proper displays and screens in an X Windows networked environment.

CPU units are a relative index of the processing power required by the remote desktop. This can be a normalized measure of processing power on each of the remote computers or can specify an absolute measure of processing power. For example, this can indicate MIPs, SPEC marks, or other measurements of processor speeds. Similarly, disk units and network bandwidth can be relative or absolute measurements of these respective computer resources. For example, disk units and network bandwidth can be specified as low, medium, and high or in their absolute measurements. For example, low disk amount and bandwidth could be set to 2 Gigabytes of storage and 10 Megabits of bandwidth while high disk amount and bandwidth could be 2 Terabytes and 10 Gigabits of bandwidth on a remote computer. In each implementation, CPU units, disk units, and network bandwidth can each be specified independently as needed by the user or application.

Applications in icon table 302 specify the desired applications to be run using the various computer resources. Generally, an icon specifying one application would run the application when the icon is selected. If multiple applications are selected, it is possible that multiple applications would be also be run when the remote desktop is executed. Alternatively the user would manually invoke the applications once the remote desktop starts running.

Authentication table 304 in FIG. 3 includes information for authenticating and authorizing users to process certain applications. In one implementation, authentication table 304 includes a user id, authentication information, and allowed RC or remote computers. Upon setting up the icons and computer resources in accordance with the present invention, the user may be required to provide authentication information for running each remote desktop and application. The user ID could be a UNIX user or group id or any other identifier compatible with PAM or other authentication schemes. Certain authentication information provided in advance can be used to locate one or more RC (remote computers) that have the required computer resources and would authorize the particular user access to the computer resources. For example, user id 3 has provided authentication information p7 and has authorization to use computer resources on remote computers 9, 1, 2, and 4 if they are available. Collecting authentication information in advance streamlines using the remote desktop and makes remote desktop operations easier to use.

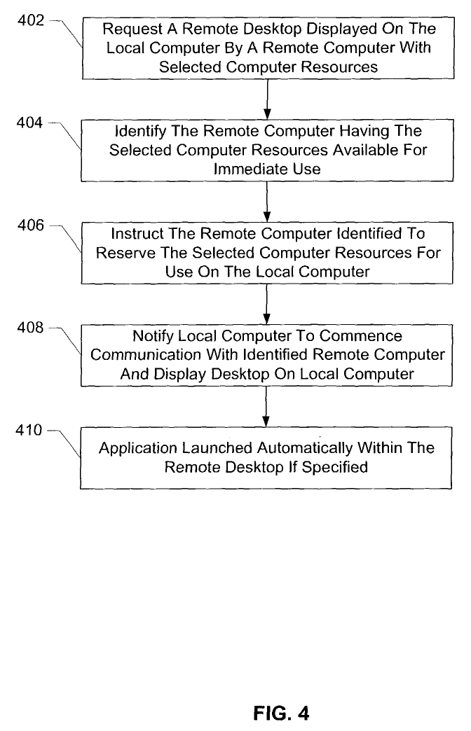

FIG. 4 is a flowchart diagram of the operations for accessing a remote desktop from a local computer in accordance with one implementation of the present invention. These operations mask or eliminate the complexity of accessing a suitable remote desktop by a user. In one implementation, an icon configured as previously described can access a remote computer through a remote desktop with a single-click of a pointing device or very few keystrokes. For example, a single-click on an iconic representation using a pointing device causes the remote computer server to provide the remote desktop representing the remote computer and desired computer resources.

This initial single-click or invocation sends a request to display a remote desktop from a remote computer having the selected computer resources (402). As previously described, the icon represents a request for a combination of desired computer resources rather than a particular remote computer. The user selecting the icon on the desktop of a local computer (LC1) knows the resulting remote desktop will have selected resources, capabilities or run a certain application yet is not concerned with the topology of the network or the particular remote computer selected.

In response, identifying the remote computer having the selected computer resources available for immediate use is identified (404). In one implementation, the request for the selected computer resources is transmitted to a remote computer server for fulfillment. The remote computer server invokes a resource management layer (RML) to interact with the different remote computer agents and gather information.

The RML of the remote computer server queries these multiple remote computer (RC) agents to determine if the desired computer resources are available on one or more remote computers. For example, if the computer resources are available then a single remote computer RCx is identified by the RML on the remote computer server. Alternatively, if multiple computers meet or substantially meet the computer resource requirements than multiple remote computers RCx through RC_{z} are identified and one is selected by the remote computer server. In general, the remote computer server and the RML compares the selected computer resources with the computer resources indicated by the one or more agents as belonging to the one or more remote computers and then selects the remote computer suggested by the one or more agents that substantially provides the selected computer resources.

With the remote computer identified and computer resources available for immediate use, the remote computer agent instructs the remote computer identified to reserve the selected computer resources for use on the local computer (406). In one implementation, the RC Agent_{X} reserves these computer resources for the local computer by creating desktop server process on RC_{X}. In a UNIX or Linux environment, the RC Agent_{X} on RC_{X} forks off a shell process with the user as owner for access rights and accounting purposes. The shell performs initializations specific to the user and further invokes, for example, a VNC server as the desktop server application under UNIX or Linux or any other appropriate desktop server application. Desktop server application delays delivery of the remote desktop by the remote desktop server until a corresponding remote desktop client on the local computer is capable of processing or communicating with the remote desktop.

Meanwhile, another RC Agent associated with the local computer notifies the local computer to commence communication with the identified remote computer and display a desktop from the remote computer on the local computer (408). In one implementation, RC Agent on the local computer starts the desktop client process to communicate with the desktop server process on the remote computer. RC Agent on the local computer forks a different shell process under UNIX or Linux that invokes a VNC client as the desktop client process. The VNC client operating as the desktop client process receives and presents the remote desktop being transmitted by the VNC server or desktop server process running on the selected remote computer. This remote desktop is established on the local computer with a single-click or minimal effort once both the desktop client process and desktop server process have been started.

An application may also be launched automatically within the remote desktop if the user specifies it (410). Even if it is launched automatically, the application appearing in the remote desktop on the local computer may require additional parameters or login information to properly operate. For example, the user may be required to provide additional login passwords or keys for operating the software on the remote computer. Frequently, applications are not started automatically as the keystroke sequence or selections on the graphical user interface are overly complicated and difficult to automate.

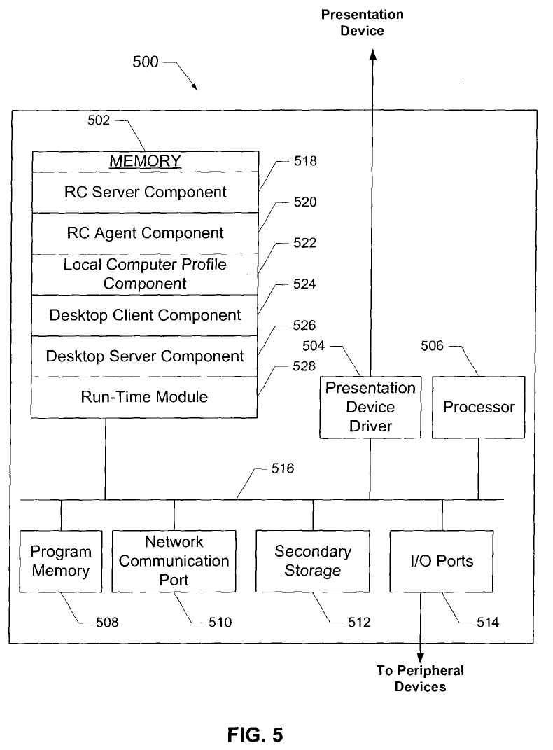

FIG. 5 is a block diagram of a system 500 used in one implementation for performing apparatus or method of the present invention. System 500 includes a memory 502 to hold executing programs (typically random access memory (RAM) or writable read-only memory (ROM) such as a flash ROM), a presentation device driver 504 capable of interfacing and driving a display or output device, a program memory 508 for holding drivers or other frequently used programs, a network communication port 510 for data communication, a secondary storage 512 with secondary storage controller, and input/output (I/O) ports 514 also with I/O controller operatively coupled together over a bus 516. The system 500 can be preprogrammed, in ROM, for example, using field-programmable gate array (FPGA) technology or it can be programmed (and reprogrammed) by loading a program from another source (for example, from a floppy disk, a CD-ROM, or another computer). Also, system 500 can be implemented using customized application specific integrated circuits (ASICs).

In one implementation, memory 502 includes a remote computer (RC) server component 518, a remote computer (RC) agent component 520, a local computer profile component 522, a desktop client component 524, a desktop server component 526, and a run-time module 528 that manages the resources used on system 500 as used by implementations of the present invention.

As previously described, RC server component 518 manages requests for computer resources available on remote computers. RC server component 518 interacts with RC agents on both the local computer and remote computers. RC agent component 520 operates on both the local computer and remote computers. On the local computer, RC agent component 520 transmits requests for computer resources and receives responses from RC server component 518. In contrast, RC agent component 520 running on a remote computer receives requests for available computer resources on the remote computer from RC server component 518 and determines whether a particular remote computer has the requested combination of computer resources available.

As previously described, icon and authentication information is contained in local computer profile component 522 and includes the association between an icon and various desired computer resources. If a remote computer has the required computer resources, desktop client component 524 renders the remote desktop on a local computer based on information delivered over a network by desktop server component 526 running on the remote computer.

While examples and implementations have been described, they should not serve to limit any aspect of the present invention. Accordingly, implementations of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs.

Furthermore, while specific embodiments have been described herein for purposes of illustration, various modifications may be made without departing from the spirit and scope of the invention. For example, the request for computer resources on a remote computer system can include specific values or a range of values. A user can specify a remote computer having processor clock greater than 1 GHz, disk space greater than 20 GB, and a bandwidth of at least 256K bps. Alternatively, a user may request computer resources using both specific values and a range of values. The processor speed requested can be 1.26 GHz yet disk space requested may be at least 20 GB and the bandwidth at least 256K bps. Accordingly, the invention is not limited to the above-described implementations, but instead is defined by the appended claims in light of their full scope of equivalents.

What is claimed is:

1. A method of accessing a remote desktop from a local computer, comprising:
requesting a remote desktop to be displayed on the local computer and computed by a remote computer having selected computer resources;
identifying the remote computer having the selected computer resources available for immediate use;
instructing the remote computer identified to reserve the selected computer resources for use on the local computer; and
notifying the local computer to commence communication with the identified remote computer and display a desktop from the remote computer on the local computer.

2. The method of claim 1 wherein the request for the remote desktop is made by selecting an icon on a local desktop associated with the selected computer resources.

3. The method of claim 1 wherein the selected resources are selected from a set of resources including: a processor capacity, a disk storage amount, a network bandwidth, a cache amount, a memory amount, and applications available for execution on the remote computer on behalf of the local computer through the remote desktop.

4. The method of claim 1 wherein identifying further comprises:
transmitting the request for the selected computer resources to a remote computer server that queries one or more agents associated with corresponding one or more remote computers;
comparing the selected computer resources with the computer resources indicated by the one or more agents as belonging to the one or more remote computers; and
selecting the remote computer suggested by the one or more agents that substantially provides the selected computer resources.

5. The method of claim 1 wherein instructing the remote computer identified further comprises:
creating a remote desktop server on the identified remote computer configured to deliver the remote desktop to the local computer requesting the computer resources.

6. The method of claim 5 further comprising:
delaying delivery of the remote desktop by the remote desktop server until a remote desktop client on the local server is capable of processing the remote desktop.

7. The method of claim 5 further comprising:
reserving the computer resources for the requesting local computer and making them unavailable on the identified remote computer.

8. The method of claim 5 wherein notifying the local computer, further comprises:
transmitting an acknowledgement to the local computer that the requested resources have been located; and
creating a remote desktop client on the local server to communicate with and process the remote desktop being delivered by the remote computer desktop server on the remote computer.

9. A computer program product, tangibly stored on a computer-readable medium, for accessing a remote desktop from a local computer, comprising instructions operable to cause a programmable processor to:
request a remote desktop to be displayed on the local computer and computed by a remote computer having the selected computer resources;
identify the remote computer having the selected computer resources available for immediate use;
instruct the remote computer identified to reserve the selected computer resources for use on the local computer; and
notify the local computer to commence communication with the identified remote computer and display the remote desktop on the local computer.

10. An apparatus for accessing a remote desktop from a local computer, comprising:
means for requesting a remote desktop to be displayed on the local computer and computed by a remote computer having the selected computer resources;
means for identifying the remote computer having the selected computer resources available for immediate use;
means for instructing the remote computer identified to reserve the selected computer resources for use on the local computer; and
means for notifying the local computer to commence communication with the identified remote computer and display the remote desktop on the local computer.

11. A method of generating a request for computer resources, comprising:
creating on a local computer an iconic representation in a graphical user interface of a remote desktop from a remote computer;
associating desired computer resources with the iconic representation of the remote desktop; and
registering the icon and associated computer resources with a remote computer server capable of locating the remote computer with the desired computer resources upon demand.

12. The method of claim 11 wherein associating the desired computer resources further comprises grouping the computer resources in a profile.

13. The method of claim 111 wherein the computer resources are selected from a set of computer resources including: a processor capacity, a disk storage amount, a network bandwidth, a cache amount, a memory amount, and applications available for execution on the remote computer on behalf of the local computer through the remote desktop.

14. The method of claim 11 wherein registering further comprises:
authenticating one or more users associated with the iconic representation of the remote desktop; and
authorizing the one or more users associated with the remote desktop for subsequent access to the computer resources on one or more remote computers.

15. The method of claim 11 wherein a single-click on the iconic representation using a pointing device causes the remote computer server to provide the remote desktop representing the remote computer and desired computer resources.

16. The method of claim 15 wherein the remote computer server providing the remote desktop further comprises:
transmitting the request for the selected computer resources from the remote computer server to one or more agents associated with corresponding one or more remote computers;
comparing the selected computer resources with the computer resources indicated by the one or more agents as belonging to the one or more remote computers; and
selecting the remote computer suggested by the one or more agents that substantially provides the selected computer resources.

17. The method of claim 16 further comprising:
creating a remote desktop server on the selected remote computer configured to deliver the remote desktop to the local computer requesting the computer resources.

18. The method of claim 17 further comprising:
delaying delivery of the remote desktop by the remote desktop server until a remote desktop client on the local server is capable of processing the remote desktop.

19. A computer program product, tangibly stored on a computer-readable medium, for generating a request for computer resources, comprising instructions operable to cause a programmable processor to:
create on a local computer an iconic representation in a graphical user interface of a remote desktop from a remote computer;
associate desired computer resources with the iconic representation of the remote desktop; and
register the icon and associated computer resources with a remote computer server capable of locating the remote computer with the desired computer resources upon demand.

20. The computer program product of claim 19 further comprising instructions wherein a single-click on the iconic representation using a pointing device causes the remote computer server to provide the remote desktop representing the remote computer and desired computer resources.

21. An apparatus for generating a request for computer resources, comprising:
means for creating on a local computer an iconic representation in a graphical user interface of a remote desktop from a remote computer;
means for associating desired computer resources with the iconic representation of the remote desktop; and
means for registering the icon and associated computer resources with a remote computer server capable of locating the remote computer with the desired computer resources upon demand.

22. The apparatus of claims 21, further comprising:
means for producing a single-click on the iconic representation causing the remote computer server to provide the remote desktop representing the remote computer and desired computer resources.
